(19) United States
(12) Patent Application Publication
(10) Pub. No.: US 2012/0214142 A1
(43) Pub. Date: Aug. 23, 2012

(54) WORK PROCEDURE GUIDANCE SYSTEM

(75) Inventor: Yoshihide Togawa, Asaka-shi (JP)

(73) Assignee: HONDA MOTOR CO., LTD., Tokyo (JP)

(21) Appl. No.: 13/504,495

(22) PCT Filed: May 26, 2010
(86) PCT No.: PCT/JP2010/058870

§ 371 Date: Apr. 27, 2012

(30) Foreign Application Priority Data
Oct. 29, 2009 (JP) 2009-249046
Oct. 29, 2009 (JP) 2009-249051

(51) Int. Cl. G09B 19/00

(52) U.S. Cl. 434/219

(57) ABSTRACT

The work guidance unit of a work procedure guidance system calculates, using the data in a work database, the total standard man-hour and the removal/attachment procedures up to the removal/attachment of a designated part. Then, among the plurality of calculated removal/attachment procedures, guidance is provided for the removal/attachment procedure requiring the at least standard man-hours up to the removal/attachment of the aforementioned part.

### TECHNICAL FIELD

The present invention relates to an operating (work) procedure guidance system for guiding the worker through an operating procedure for either one or both of removing a part attached to an apparatus and installing the part on the apparatus.

### BACKGROUND ART

There have been known electronic manuals, which are used as repair manuals for repairing and adjusting apparatus (see Japanese Laid-Open Patent Publication No. 2003-156993). According to Japanese Laid-Open Patent Publication No. 2003-156993, manuals concerning registered jobs are stored in a memory in a workshop or the like. When the worker selects a target job to be performed from a menu that displays a hierarchical list of job types, operation steps that perform the procedure of the target job are specified, and an explanation of operations in the operational steps are displayed from stage to stage (see paragraphs [0011] and [0034] through [0038] of the document).

### SUMMARY OF INVENTION

According to Japanese Laid-open Patent Publication No. 2003-156993, as described above, operation manuals required for respective operation steps, which are registered for the target job that has been selected by the worker from among a plurality of registered jobs, are displayed. However, this publication discloses nothing about generation of operating procedures, or the selection of combinations of operation steps.

For repairing apparatus that have many parts, such as vehicles, it has been customary to display and explain standard operating procedures in order with electronic manuals for installing and/or removing representative parts that must be serviced highly frequently. However, since not all of the standard operating procedures for installing and/or removing parts are displayed and explained, during actual work, the worker is required to select the generation of appropriate operating procedures by referring to related standard operating procedures, which are shown in service manuals or the like.

There are instances in which the worker must be free to select operating procedures at his or her discretion. For example, a worker may need to choose either a procedure for reaching a target part by detaching other parts that are positioned in front of the target part, or a procedure for reaching a target part by detaching other parts that are positioned behind the target part. Alternatively, the worker may need to choose either a procedure for detaching a target part by detaching an overall unit that includes the target part from a vehicle body, or a procedure for successively detaching other parts related to a target part while leaving the overall unit attached to the vehicle body. Operating efficiency may often differ greatly depending on which procedure is selected by the worker.

Furthermore, if there are a plurality of parts to be serviced, then it is important to choose an efficient operating procedure, in view of operations that are common to such parts. It is very difficult, even for highly experienced or skilled workers, to select such an operating procedure.

The present invention has been made in view of the above problems. It is an object of the present invention to provide an operating procedure guidance system, which is capable of guiding the worker efficiently through an operating procedure that leads up to the removal and/or installation of a target part.

Another object of the present invention is to provide an operating procedure guidance system, which is capable of guiding the worker through a necessary removal and installation procedure, even if there are a plurality of removal and installation procedures that lead up to the removal and/or installation of a target part.

According to the present invention, there is provided an operating procedure guidance system for guiding a worker through an operating procedure for either one or both of removing a part attached to an apparatus and installing the part on the apparatus, comprising a working database for storing, with respect to each of operations for respective parts, a pair of an order for removal or installation in connection with other parts, and required standard man-hours, an input unit for indicating a target part to be removed or installed, and an operation guidance unit for calculating a removal and installation procedure for removal or installation of the indicated target part and a total standard man-hours therefor, using data stored in the working database, and guiding the worker through the removal and installation procedure using calculated results. The operation guidance unit guides the worker through a removal and installation procedure, for which the total standard man-hours required for removal or installation of the target part is minimum, among a plurality of calculated removal and installation procedures.

According to the present invention, for removing and/or installing a target part selected by the worker, it is possible to guide the worker through a removal and installation procedure, the total standard man-hours of which is minimum, and to calculate overall man-hours with ease.

When a plurality of target parts are indicated through the input unit, the operation guidance unit may guide the worker through one of all of the combinations of removal and installation procedures, for which the total standard man-hours required for either one or both of removal and installation of the indicated target parts is minimum. The operation guidance unit can eliminate overlapping operations for removal and/or installation of related parts required by operations for removing and/or installing a plurality of target parts, can guide the worker through a minimum number of removing and installing operations for removing and/or installing the target parts, and can calculate the total man-hours appropriately.

The operation guidance unit may display the total standard man-hours for each removing and installing operation for guiding the worker through the removal and installation procedure. Accordingly, the worker can compare the total standard man-hours for the operation for removing and/or installing each part with actual man-hours, in order to confirm the level of skill.

If there are a plurality of removal and installation procedures, the total standard man-hours of which is minimum, then the operation guidance unit may select a procedure that includes most of the operations selected by the worker. The operation guidance unit is thus capable of guiding the worker preferentially through one of the removal and installation procedures, the total standard man-hours of which is minimum, and which the worker considers more preferable, including removal and installation procedures that the worker is skilled enough to perform.

According to the present invention, there also is provided an operating procedure guidance system for guiding the worker through an operating procedure for either one or both of removing a part attached to an apparatus and installing the part on the apparatus, comprising a working database for storing, with respect to each of operations for respective parts, a combination of an order for either one or both of removal and installation in connection with other parts, required standard man-hours, and operation description data in combination, an input unit for indicating a target part to be removed or installed, and an operation guidance unit for calculating a removal and installation procedure for removal or installation of the indicated target part and a total standard man-hours therefor, using data stored in the working database, and guiding the worker through the removal and installation procedure, wherein the operation guidance unit selects a removal and installation procedure for which the total standard man-hours for removal or installation of the indicated target part is minimum, and displays operation description data for the target part and related parts up to the target part, along and in combination with the selected removal and installation procedure.

According to the present invention, a combination of operation description data, which are preset for respective removal and installation procedures, are not displayed successively, but rather, operation description data for respective operations of parts can be recombined and displayed depending on the selected removal and installation procedure. Therefore, even if there are a plurality of removal and installation procedures, it is not necessary to prepare a plurality of combinations of operation description data, but rather, the operation description data can be recombined and displayed depending on a selected removal and installation procedure, resulting in high versatility. According to the present invention, furthermore, the operation description data can be recombined and displayed along with a removal and installation procedure the total standard man-hours of which is minimum. Accordingly, the worker is capable of performing efficient operations regardless of the experience and skill of the worker.

When a plurality of target parts are indicated through the input unit, the operation guidance unit may display the operation description data for the target parts and related parts up to the target parts, along and in combination with one of all of the combinations of removal and installation procedures, for which the total standard man-hours for either one or both of removal and installation of the indicated target parts is minimum. Consequently, the worker can perform efficient operations even if a plurality of target parts are indicated. Such efficient operations are highly advantageous, particularly when a large apparatus including a vast number of parts, such as a vehicle, is to be serviced.

### BRIEF DESCRIPTION OF DRAWINGS

FIG. 1 is a block diagram of an operating procedure guidance system according to an embodiment of the present invention;

FIG. 2 is a diagram showing an example of a screen displayed on a monitor of the operating procedure guidance system;

FIG. 3 is a diagram showing a database of information of parts corresponding to a tree diagram displayed on the screen shown in FIG. 2;

FIG. 4 is a diagram showing a removal and installation procedure for changing a door latch;

FIG. 5 is a diagram showing a simplified example of a screen displayed on the monitor for changing a door latch;

FIG. 6 is a diagram showing a removal and installation procedure for changing an outer door handle;

FIG. 7 is a diagram showing a simplified example of a screen displayed on the monitor for changing an outer door handle;

FIG. 8 is a diagram showing a removal and installation procedure for changing a door latch and an outer door handle;

FIG. 9 is a diagram showing a modeled example of a detailed configuration of a screen displayed on the monitor for changing a door latch and an outer door handle;

FIG. 10 is a diagram showing an example of data stored in a working database used in the operating procedure guidance system;

FIG. 11 is a diagram showing an example of association between data in the working database;

FIG. 12 is a flowchart of a general processing sequence carried out by the operating procedure guidance system;

FIG. 13 is a flowchart of a portion of a subroutine sequence of the flowchart shown in FIG. 12, which is representative of a processing sequence for selecting an optimum combination from among combinations between target parts and related parts; and

FIG. 14 is a flowchart of the remainder of the subroutine sequence of the flowchart shown in FIG. 12, which is representative of a processing sequence for selecting an optimum combination from among combinations between target parts and related parts.

### DESCRIPTION OF EMBODIMENTS

### A. Embodiment

1. System Configuration:

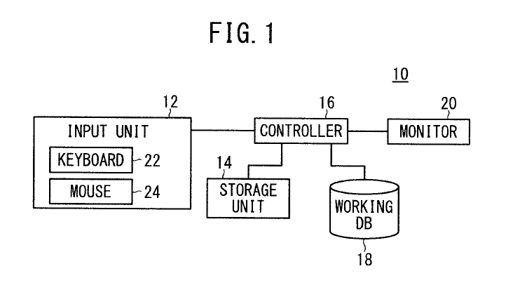

FIG. 1 is a block diagram of an operating procedure guidance system 10 (hereinafter referred to as a “guidance system 10”) according to an embodiment of the present invention. The guidance system 10 according to the present embodiment is installed in a vehicle service shop and serves to guide the worker through an operating procedure for performing maintenance on a vehicle. The guidance system 10 includes an input unit 12, a storage unit 14, a controller 16, a working database 18 (hereinafter referred to as a “working DB 18”), and a monitor 20.

The input unit 12, which comprises a keyboard 22 and a mouse 24, is capable of entering a servicing operation to be performed (hereinafter referred to as a “target operation Ot”), and a part to be handled in the servicing operation (hereinafter referred to as a “target part Pt”) in response to an action made by the worker. In the present embodiment, the target operation Ot refers to a changing operation. However, an operation for inspecting, adjusting, machining, removing and installing (without changing), attaching or installing (without detaching or removing), or detaching or removing (without attaching or installing) a part may also be referred to as the target operation Ot. In the present embodiment, the input unit 12 also allows the worker to directly enter the target operation Ot. Direct entry of the target operation Ot, rather than the target part Pt, will be described below.

The storage unit 14 includes a nonvolatile memory and a volatile memory, and stores a program for guiding the worker through an operating procedure for performing maintenance (operating procedure guidance program). The controller 16 includes a central processing unit (CPU), and the controller 16 guides the worker through an operating procedure, i.e., the target operation Ot and an operation required in connection with the target operation Ot (hereinafter referred to as a “related operation Or”). More specifically, the controller 16 displays explanations of the target operation Ot and the related operation Or on the monitor 20. The working DB 18 stores data required for the controller 16 to guide the worker through the operating procedure.

2. Outline of Functions:

Functions of the guidance system 10, with respect to an example of a process for removing and/or installing a door of a vehicle, including a system operation sequence, will briefly be described below.

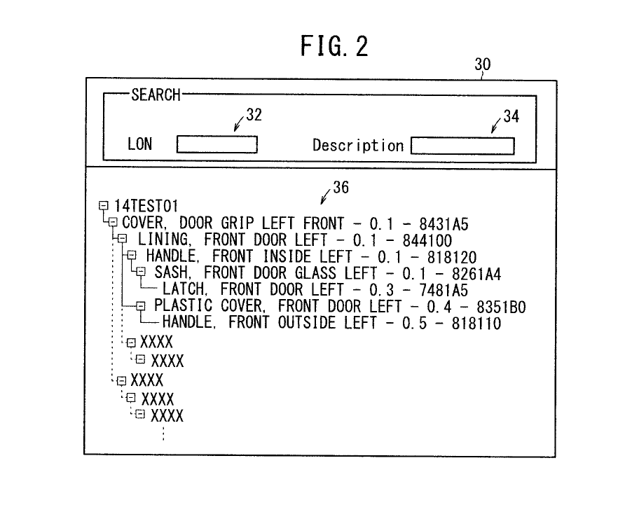

FIG. 2 shows a screen 30 as an example of a screen displayed on the monitor 20. As shown in FIG. 2, the screen 30 includes a LON entry field 32, a target part name entry field 34, and a tree diagram 36.

The LON entry field 32 is a field for entering an operation number (hereinafter referred to as a “LON” (labor operation number)). The target part name entry field 34 is a field for entering the name of the target part Pt. Methods for using such fields will be described later.

The tree diagram 36 represents the order in which parts are removed and/or installed. “14TEST01” on the foremost upstream side (left side in FIG. 2) of the tree diagram 36 represents a number that is assigned to a type (type number). Lines displayed downstream from the type number “14TEST01”, e.g., “COVER, DOOR GRIP LEFT FRONT—0.1—8431A5”, represent information of the target operation Ot, which is recognized for the respective parts.

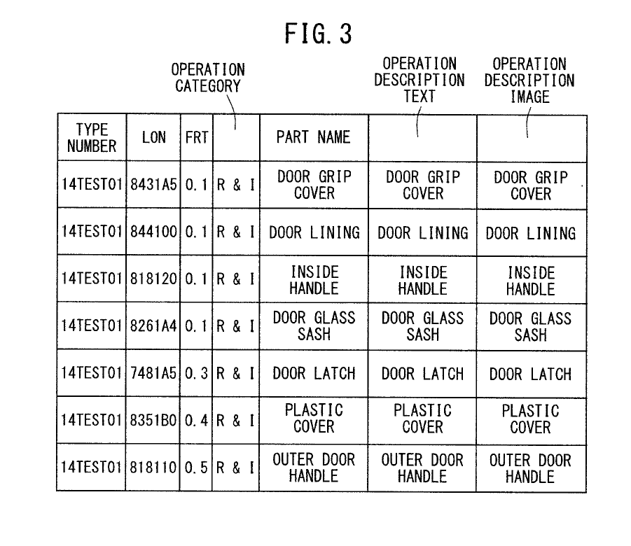

FIG. 3 shows an example of information of the target operation Ot for each of parts that correspond to the tree diagram 36. As shown in FIG. 3, information of the target operation Ot for each of the parts corresponding to the tree diagram 36 represents a LON, standard operating man-hours (hereinafter referred to as “FRT” (flat rate time)), an operation category, a part name, an operation description text describing contents of removal and installation operations in the operation category, and an operation description image illustrating the part that is removed and/or installed in relation to nearby parts.

A LON is assigned to each part removing and installing operation. The FRT represents standard operating man-hours required to remove and/or install a part or to change a part. The operation category is represented by removal and installation (R&I), inspection, adjustment, machining, installation, removal, etc.

All of the operations, which are to be carried out in reality, have been registered in advance. If there are different operations to handle a single part, e.g., if different man-hours are required to remove and install a target part Pt when other parts positioned in front of the target part Pt are required to be detached successively and when other parts positioned behind the target part Pt are required to be detached successively, or if different man-hours are required to remove and install the target part Pt when an overall unit is detached from the vehicle body or when the overall unit remains attached to the vehicle body, then such operations are indicated by a branch number following the same LON with a hyphen therebetween (e.g., XXX-X), thereby indicating that the operations differ from each other, although such operations are performed to remove and install the same part.

Dedicated added man-hours, common added man-hours, and a preceding operation number (hereinafter referred to as a “preceding LON”), which will be described later, are omitted from illustration in FIG. 3.

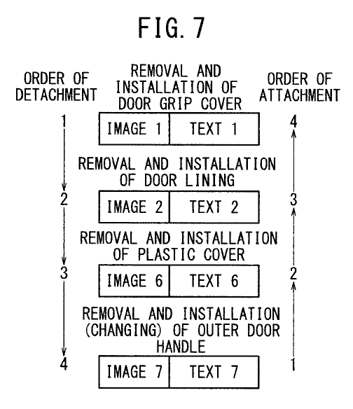

As shown in FIG. 2, the tree diagram 36 allows the worker to see the order in which to detach parts (and the order in which to attach parts subsequently thereto). More specifically, in order to change a door latch (front left) (LATCH FRONT DOOR LEFT), a door glass sash (front left) (SASH, FRONT DOOR GLASS LEFT) must be detached beforehand. In order to detach the door glass sash, an inside handle (front left) (HANDLE, FRONT INSIDE LEFT) must be detached beforehand. In order to detach the inside handle, a door lining (front left) (LINING, FRONT DOOR LEFT) must be detached beforehand. In order to detach the door lining, a door grip cover (front left) (COVER, DOOR GRIP LEFT FRONT) must be detached beforehand. In this example, the detachment of the door grip cover is the foremost up-stream operation. In FIGS. 3 through 9, the term “(FRONT LEFT)” has been omitted from illustration.

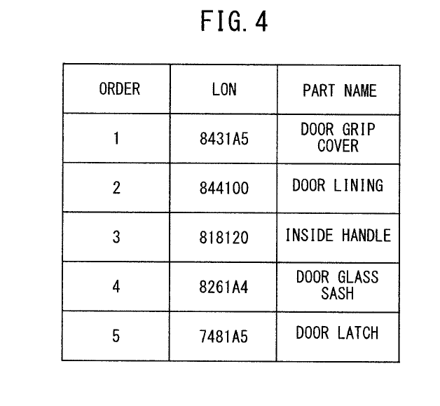

If the worker selects a door latch as the target part Pt (by moving the cursor with the mouse 24 to the door latch on the 6th line in the tree diagram 36 shown in FIG. 2, thereby selecting the line and executing the selection), the guidance system 10 searches through all of the registered operating routes, including branch numbers up to LON=7481A5, in order to judge a route (operating procedure) in which the total man-hours is minimum. As shown in FIG. 4, according to a removal and installation procedure for changing the door latch, the guidance system 10 determines that it is necessary to detach (remove) a door grip cover, a door lining, an inside handle, and a door glass sash. Further, according to a procedure after the door latch has been changed, the guidance system 10 also determines that it is necessary to attach (install) the door glass sash, the inside handle, the door lining, and the door grip cover.

Based on the above decisions, the guidance system 10 guides the worker through removing and installing operations as the related operation Or and the target operation Ot. In the illustrated example, the guidance system 10 guides the worker through respective removing and installing operations for changing the door latch, thereby guiding the worker through the procedure of changing the door latch.

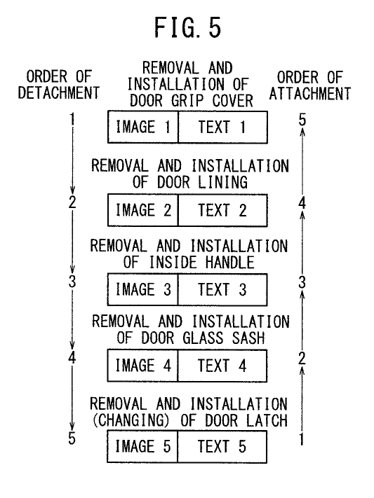

As shown in FIG. 5, the monitor 20 of the guidance system 10 displays images and texts for explaining respective removing and installing operations. In FIG. 5, when the displayed screen is scrolled, the monitor 20 displays all of the removing and installing operations. However, the worker may also toggle screens for respective parts by operating the mouse 24.

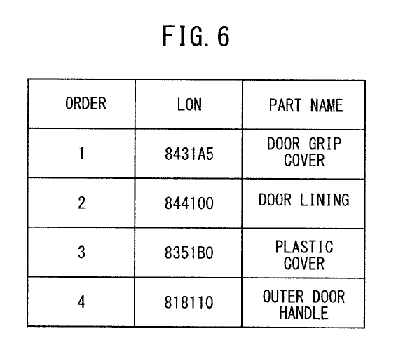

If the worker selects an outer door handle as the target part Pt (by moving the cursor to the door latch on the 8th line in the tree diagram 36 shown in FIG. 2 with the mouse 24, selecting the line, and executing the selection), then the guidance system 10 searches all of the registered operating routes including branch numbers up to LON=818110, in order to judge a route (operating procedure) in which the total man-hours is minimum. As shown in FIG. 6, according to a removal and installation procedure for changing the outer door handle, the guidance system 10 determines that it is necessary to detach (remove) a door grip cover, a door lining, and a plastic cover. Based on this decision, the guidance system 10 guides the worker through respective removing and installing operations as the related operation Or and the target operation Ot. In the illustrated example, the guidance system 10 guides the worker through removing and installing operations for changing the outer door handle, thereby guiding the worker through a procedure for changing the outer door handle.

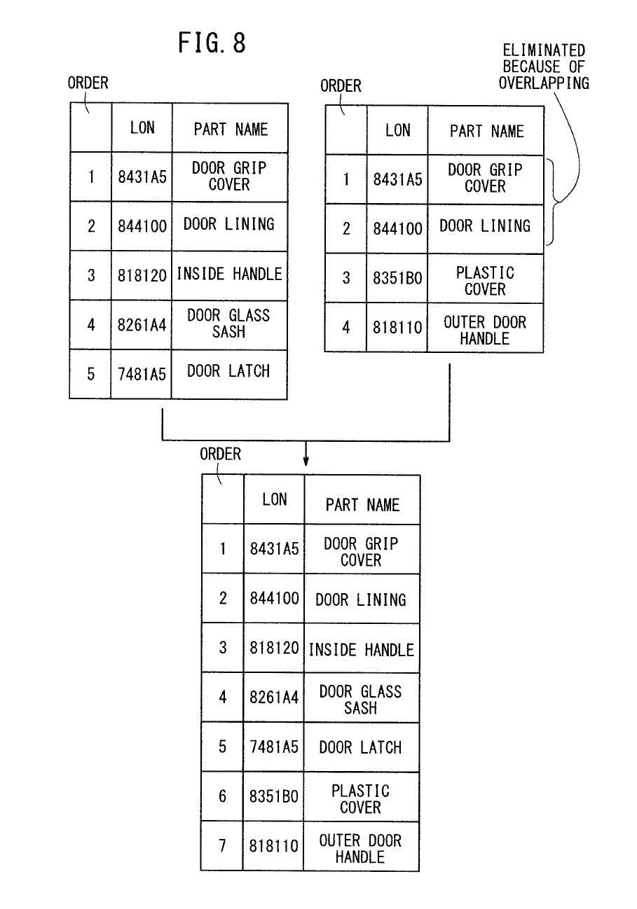

As described above, the worker has selected a door latch (FIGS. 4 and 5) and an outer door handle (FIGS. 6 and 8) as individual parts. The guidance system 10 may also simultaneously select a plurality of parts.

For example, if the worker selects a door latch and an outer door handle as target parts Pt (by moving the cursor to the door latch on the corresponding line with the mouse 24, selecting the line, and thereafter, moving the cursor to the outer door handle on the corresponding line with the mouse 24, selecting the line, and executing the selections), the guidance system 10 guides the worker through removal and installation procedures having a minimum number of man-hours in one operation, for thereby removing and installing the door latch and the outer door handle. More specifically, as shown in FIG. 8, according to a removal and installation procedure for changing the door latch, the guidance system 10 determines that it is necessary to detach (remove) a door grip cover, a door lining, an inside handle, and a door glass sash, and also, according to a removal and installation procedure for changing the outer door handle, determines that it is necessary to detach (remove) a door grip cover, a door lining, and a plastic cover. By calculating a removal and installation procedure for which the total man-hours of a series of operations is minimum, the guidance system 10 determines that detachment of the door grip cover and detachment of the door lining are present as overlapping related operations Or, and then determines a removing and installing operation having a minimum number of man-hours, according to which both operations can be carried out by one operating procedure.

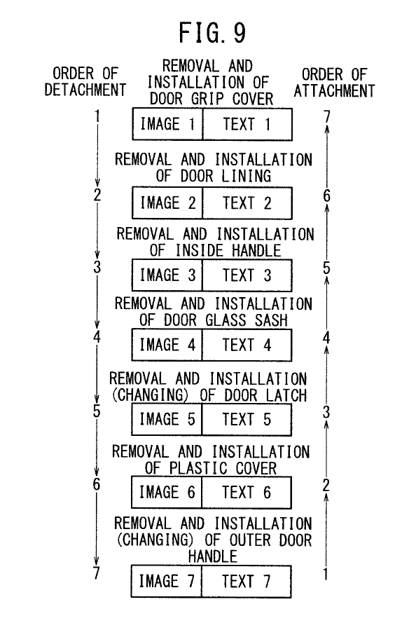

Based on the above decisions, as shown in FIG. 9, the guidance system 10 guides the worker through removing and installing operations as the related operation Or and the target operation Ot.

3. Detailed Configuration of the Working DB 18:

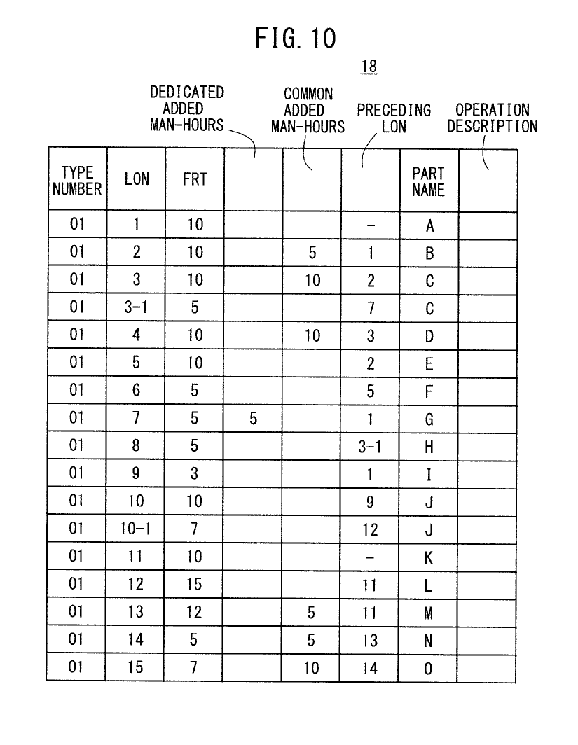

FIG. 10 shows an example, which is modeled for illustrative purposes, of a detailed configuration of data that is stored in the working DB 18. As shown in FIG. 10, the working DB 18 includes data of LONs (operation numbers), data of FRTs (standard operating man-hours), data of dedicated added man-hours, data of common added man-hours, data of preceding operation numbers (hereinafter referred to as “preceding LONs”), data of part names, and data of operation explanations.

A LON is assigned to each part removal and installation operation. According to the present embodiment, as described above, equivalent LONs are distinguished from each other by hyphens and numbers as branch numbers (e.g., 3, 3-1, 3-2). Equivalent LONs refer to processes of removing and installing a given individual part with different removal and installation procedures, FRTs, dedicated added man-hours, or common added man-hours. For example, equivalent LONs may be used with respect to one part if there are respective procedures for reaching the part by detaching other parts from the front side of the vehicle, and for reaching the part by removing other parts from the rear side of the vehicle. In addition, equivalent LONs may be used with respect to one part if there are respective procedures for removing the part by detaching an overall unit that includes the part from a vehicle body, and for successively detaching other parts related to the part while leaving the overall unit attached to the vehicle body.

An FRT represents standard operating man-hours required to remove and install a part or to change a part. Since a process of removing and installing a part includes removal prior to the target operation Ot and installation subsequent to the target operation Ot, as described above, an FRT refers to the total number of standard operating man-hours required for detachment prior to the target operation Ot as well as standard operating man-hours required for attachment subsequent to the target operation Ot. However, if there is a target operation Ot, which requires either one of detachment prior to the target operation Ot or attachment subsequent to the target operation Ot, then the standard operating man-hours for detachment and the standard operating man-hours for attachment may be distinguished from each other, and either one of them may be used.

Dedicated added man-hours and common added man-hours are types of added man-hours. Added man-hours refer to standard operating man-hours required for ancillary operations, such as inspection, adjustment, etc., which accompany removal and installation or changing of a part.

Dedicated added man-hours refer to standard operating man-hours required for ancillary operations, which occur only when a particular part is changed. Dedicated added man-hours are not needed when a particular part is simply removed and installed (a detached part is attached without being changed), i.e., when a part is simply removed and installed during an interim process in order to allow another part to be removed and installed. One changing operation that results in dedicated added man-hours is the changing of an alternator belt, for example, in which case the man-hours required to inspect the alternator belt when the alternator belt is changed are referred to as dedicated added man-hours.

Common added man-hours refer to standard operating man-hours required for ancillary operations, which occur when a plurality of respective particular parts are removed and installed. Since common added man-hours are required simply when any one of such particular parts is removed and installed, common added man-hours are required if the particular part is removed during the operation (i.e., if removal of the particular part is the related operation Or). If there are plurality of sets of common added man-hours for one target in the selected operating route, then one of the sets is added, and the other set or sets are treated as “0”.

Common operations include adjustment of a clutch switch and replenishment of an automatic transmission fluid (AT fluid), for example. Parts that require adjustment of the clutch switch upon removal and installation thereof include a clutch pedal, a multi-plate clutch, and the clutch switch itself, for example. Parts that require replenishment of an AT fluid upon removal and installation thereof include a torque converter, a turbine, a stator, and a pump, for example. As described later, common added man-hours may change depending on which particular part is removed and installed.

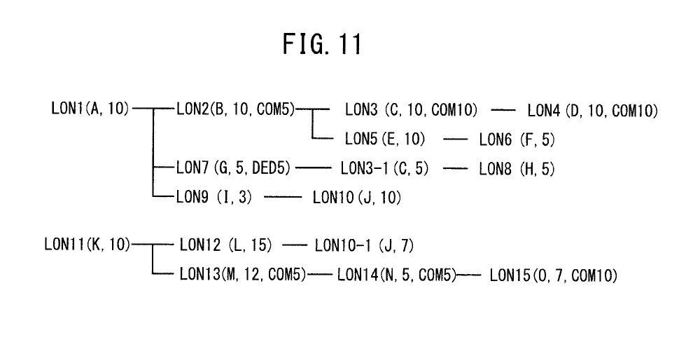

Preceding LONs refer to LONs for parts that need to be detached immediately prior to respective operations (preceding parts). Using preceding LONs, LONs are associated with each other by a tree configuration, as shown in FIG. 11, thereby making it possible to display the tree diagram 36 shown in FIG. 2.

According to the examples shown in FIGS. 10 and 11, it is necessary to perform LON3 (detachment of part C) immediately prior to LON4 (detachment of part D), it is necessary to perform LON2 (detachment of part B) immediately prior to LON3 (detachment of part C), and it is necessary to perform LON1 (detachment of part A) immediately prior to LON2 (detachment of part B).

As described above, all of the operations to be carried out in reality, including the relationships thereof to preceding LONs, are performed by the generator (data entering person) of the working DB 18. Stated otherwise, parts on the left side in FIG. 11 refer to upstream parts (parts to be detached earlier), whereas parts on the right side in FIG. 11 refer to downstream parts (parts to be detached later). In the example shown in FIG. 11, LON1 (part A) and LON11 (part K) refer to parts to be detached initially. The items in parentheses to the right of each LON in FIG. 11 represent, from the left, a part name, an FRT, and common added man-hours (“COM”, if any) or dedicated added man-hours (“DED”, if any).

The part name represents the name of a part, which is to be removed and installed or changed in the corresponding operation. For example, if the name of the part is an engine, then the part name indicates removal and installation or changing of the engine.

Explanations of the operations include images and text for explaining the operations, as shown in FIG. 3. If an operation concerns detachment (removal and installation) of a door panel, then the explanation thereof includes characters and images for explaining operating procedures for detaching inner handle fastening screws, detaching a power window switch connector, and detaching screws from a grip base. In FIG. 10, specific details of data for explaining operations and operation categories have been omitted from illustration.

4. Processing Sequence Carried Out by the Operating Procedure Guidance System:

A processing sequence, which is carried out by the operating procedure guidance system 10 according to the present embodiment, will be described below. The processing sequence described below is carried out when the controller 16 executes an operating procedure guidance program, which is stored in the storage unit 14.

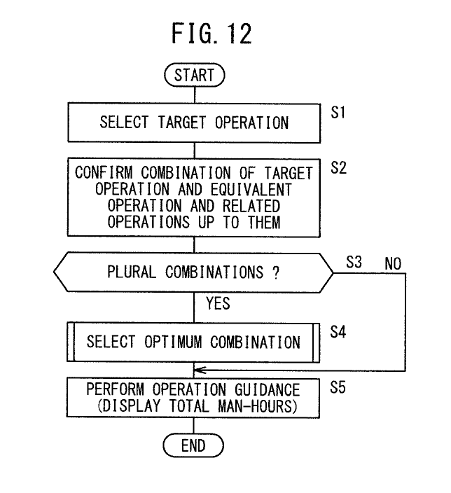

FIG. 12 shows a general processing sequence, which is carried out by the operating procedure guidance system 10 according to the present embodiment.

In step S1, a target operation Ot (LON) for a target part Pt is selected. More specifically, when the operating procedure guidance program is activated, the controller 16 displays a screen on the monitor 20, such as the screen 30 shown in FIG. 2. The screen 30 includes, in an upper area thereof, the LON entry field 32 for entering a LON, and the target part name entry field 34 for entering the name of a target part Pt. When the worker enters the LON of a target operation Ot in the LON entry field 32, and then clicks on an execution button (not shown) on the screen 30, the controller 16 displays the LON and various items of information corresponding thereto in a central area of the screen 30. When the worker enters the name of a target part Pt in the target part name entry field 34, and then clicks on the execution button, the controller 16 displays the target part Pt and various items of information corresponding thereto in the central area of the screen 30. If the entered name does not exist in the working DB 18, then the controller 16 displays information about a part, which is deemed to be closest to the entered name on the screen 30. The worker can scroll through the screen 30 vertically.

The various items of information, which are displayed in the central area of the screen 30, include a type number, a part name, an FRT, common added man-hours (if any), dedicated added man-hours (if any), and a LON. These items of information are displayed in the form of a tree diagram (see FIG. 2). Information concerning downstream parts may not be displayed in the initial screen, but may be displayed in an expanded manner when the worker operates the mouse 24 by moving the cursor to a displayed upstream part and clicking a left button on the mouse 24. The worker then selects a target operation Ot for the target part Pt using the input unit 12. For example, the worker operates the mouse 24 to move the cursor to the line of a target operation Ot and selects the line. According to the present embodiment, the above process may be repeated in order to enter a plurality of target operations Ot. After entry of the target operations Ot is completed, the worker double-clicks the left button on the mouse 24. The controller 16 then displays a message asking whether the selection is finished or not together with an OK button. When the worker clicks on the displayed OK button, control proceeds to step S2 in order to start a procedure guidance process.

In step S2, the controller 16 confirms operations equivalent to the target operation Ot (hereinafter collectively referred to as a “target operation Ot”) selected in step S1, and also confirms all of the combinations of related operations Or required by the target operation Ot. For example, in the example shown in FIG. 11, if the worker selects the removing and installing operation (LON3) for part C, then the controller 16 selects all of the LONs of other removing and installing operations (i.e., operations with branched numbers) for part C. Based on the selected LONs, the controller 16 generates all combinatorial procedures that lead up to the LONs. In the present embodiment, two combinations are generated. The first combination includes LON3 as the target operation Ot together with LON1 and LON2 as the related operations Or, and the second combination includes LON3-1 as the target operation Ot together with LON1 and LON7 as the related operations Or.

If the worker has selected a plurality of target operations Ot in step S1, then along with each of the target operations Ot, the controller 16 confirms all of the combinations of related operations Or required by each of the target operations Ot. For example, if the worker selects LON3 and LON10 in the example shown in FIG. 11, then as described below, since LON3 is equivalent to LON3-1 and LON10 is equivalent to LON10-1, the controller 16 judges that there are four available combinations of target operations Ot and related operations Or.

The first combination includes LON3 and LON3-1 as the target operations Ot, and LON1, LON2, and LON9 as the related operations Or. The second combination includes LON3-1 and LON10 as the target operations Ot, and LON1, LON7, and LON9 as the related operations Or. The third combination includes LON3 and LON10 as the target operations Ot, and LON1, LON2, LON11, and LON12 as the related operations Or. The fourth combination includes LON3-1 and LON10-1 as the target operations Ot, and LON1, LON7, LON11, and LON12 as the related operations Or.

In step S3, the controller 16 judges whether or not there are a plurality of combinations of target operations Ot and related operations Or that have been confirmed in step S2. If a plurality of combinations of target operations Ot and related operations Or exists (S3: YES), then control proceeds to step S4. If a plurality of combinations of target operations Ot and related operations Or does not exist (S3: NO), then control proceeds to step S5.

In step S4, the controller 16 selects an optimum one of the combinations of target operations Ot and related operations Or. Such an optimum combination refers to a combination that satisfies certain conditions, e.g., a condition that the total man-hours MHtotal [in minutes] is minimum.

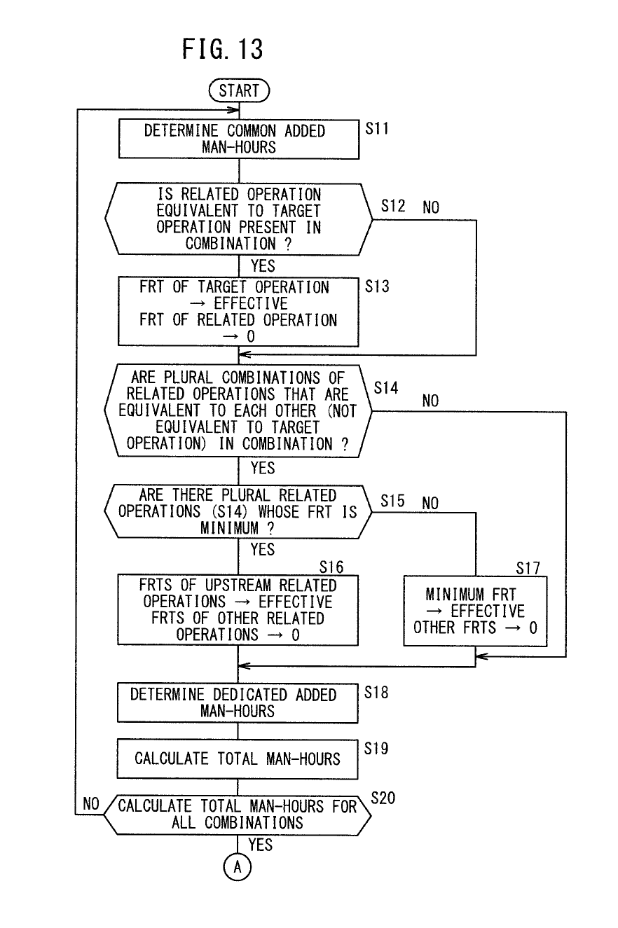

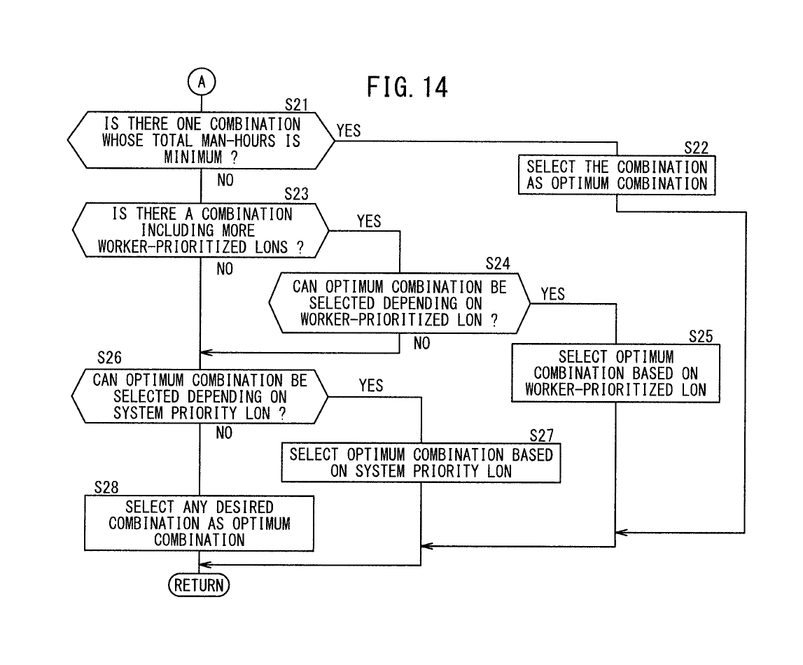

FIGS. 13 and 14 are flowcharts of a sequence (step S4 shown in FIG. 12) for selecting an optimum one of the combinations of target operations Ot and related operations Or. After one of the combinations has been selected, the controller 16 determines common added man-hours in step S11. More specifically, the controller 16 searches through the LONs of the target operations Ot and the related operations Or of the selected combination in order to locate a LON having common added man-hours therein. If there are plurality of LONs having common added man-hours, then the controller 16 judges whether or not the LONs are addressed to equivalent parts. The controller 16 can judge whether or not the LONs are addressed to equivalent parts based on identifiers of common added man-hours, which are assigned to the LONs.

If a plurality of LONs having common added man-hours are addressed to equivalent parts, then the controller 16 makes the maximum number of common added man-hours effective, while setting the other numbers of the common added man-hours to zero minutes. If there are a plurality of LONs having the maximum number of common added man-hours, the controller 16 makes the maximum number of common added man-hours of the LON selected thereby effective, while setting the other numbers of the common added man-hours to zero minutes. For example, in the example shown in FIGS. 10 and 11, the number of common added man-hours of LON2 is 5 minutes, and the number of common added man-hours of LON3 and LON4 is 10 minutes. Therefore, the controller 16 makes the number of common added man-hours of one of LON3 and LON4 effective, while setting the other of LON3 and LON4 and the number of common added man-hours of LON2 to zero. Actually, in most cases, the numbers of the common added man-hours are identical, such that if there are a plurality of numbers of common added man-hours in one route, then one of the numbers of the common added man-hours is added while the others are treated as zero.

In step S12 shown in FIG. 13, the controller 16 judges whether or not a related operation Or, which is equivalent to a target operation Ot, is present in the selected combination of target operations Ot and related operations Or.

If a related operation Or, which is equivalent to a target operation Ot, does not exist in the combination (S12: NO), then control proceeds to step S14. If a related operation Or, which is equivalent to a target operation Ot, is present in the combination (S12: YES), then in step S13, the FRT of the target operation Ot is prioritized over the FRT of the related operation Or. Stated otherwise, the controller 16 makes the FRT of the target operation Ot effective, while setting the FRT of the related operation Or to zero minutes. By making the FRT effective, the value of the FRT (see FIG. 10) is added directly to the total man-hours MHtotal in step S19, as will be described later.

In step S14, the controller 16 judges whether or not a plurality of related operations Or, which are equivalent to each other and are not equivalent to target operations Ot, exist in the selected combination of target operations Ot and related operations Or. If a plurality of such related operations Or do not exist in the combination (S14: NO), then control proceeds to step S18. If a plurality of such related operations Or does exist in the combination (S14: YES), then control proceeds to step S15. For example, if LON4 and LON5 are selected as target operations Ot in the example shown in FIGS. 10 and 11, then LON3 and LON3-1, which are equivalent to each other, exist as related operations Or. In this case, the answer in step S14 is YES.

In step S15, the controller 16 judges whether or not a plurality of related operations Or, the FRTs of which are minimum, exist among related operations Or that are equivalent to each other and not equivalent to the target operations Ot. If a plurality of such related operations Or exists (S15: YES), then in step S16, the controller 16 makes the FRTs of upstream related operations Or effective, while setting the FRTs of the other related operations Or to zero minutes. If a plurality of such related operations Or does not exist (S15: NO), then in step S17, the controller 16 makes the minimum FRTs of related operations Or effectives, while setting the FRTs of the other related operations Or to zero minutes. For example, in the example shown in FIGS. 10 and 11, if LON4 and LON8 are selected as target operations Ot, then LON3 and LON3-1, which are equivalent to each other, exist as related operations Or. The FRT of LON3 is 10 minutes, whereas the FRT of LON3-1 is 5 minutes. In this case, since the FRTs of LON3 and LON3-1 are different from each other, the answer in step S15 is NO. Therefore, in step S17, the controller 16 makes the FRT of LON3-1 effective, while setting the FRT of LON3 to zero minutes.

In step S18, the controller 16 determines dedicated added man-hours. More specifically, the controller 16 searches among the LONs of related operations Or included in the selected combination of target operations Ot and related operations Or for a LON having dedicated added man-hours. Then, the controller 16 sets the number of dedicated added man-hours corresponding to the LON of the related operation Or to zero minutes, and keeps the dedicated added man-hours corresponding to the target operations Ot effective.

In step S19, the controller 16 calculates the total man-hours MHtotal using the results from step S11 through S18. The total man-hours MHtotal is the sum of the FRTs, the common added man-hours (those effective), and the dedicated added man-hours (those effective).

In step S20, the controller 16 judges whether or not the total man-hours MHtotal with respect to all of the combinations of target operations Ot and related operations Or have been calculated. If there are remaining combinations for which the total man-hours MHtotal have not been calculated (S20: NO), then control returns to step S11, whereupon the controller 16 calculates the total man-hours MHtotal with respect to one of the combinations for which the total man-hours MHtotal have not been calculated. If the total man-hours MHtotal have been calculated with respect to all of the combinations (S20: YES), then control proceeds to step S21 shown in FIG. 14.

In step S21 in FIG. 14, the controller 16 judges whether or not there is one combination of target operations Ot and related operations Or, the total man-hours MHtotal of which is minimum. If one such combination exists (S21: YES), then in step S22, the controller 16 selects the combination as an optimum combination. If there a plurality of such combinations, the total man-hours MHtotal of which is minimum (S21: NO), then in step S23, the controller judges whether or not there is a combination including more worker-prioritized LONs than the other combinations. A worker-prioritized LON refers to a LON that has actually been selected by the worker using the mouse 24. For example, if the worker selects LON3-1 as a target operation Ot, then LON3-1 is a worker-prioritized LON, and LON3, which is equivalent to LON3-1, is a non-worker-prioritized LON.

If there is a combination including more worker-prioritized LONs than any of the other combinations (S23: YES), then control proceeds to step S24. If there is no such combination, i.e., if all of the combinations have the same number of worker-prioritized LONs, (S23: NO), then control proceeds to step S26.

In step S24, the controller 16 judges whether or not an optimum combination can be selected from a plurality of combinations, the total man-hours MHtotal of which is minimum based on the worker-prioritized LON. For example, the controller 16 judges whether or not an optimum combination can be selected in the following manner. First, the controller 16 judges whether or not one combination exists, which includes the most worker-prioritized LONs from among a plurality of combinations the total man-hours MHtotal of which is minimum. If such a combination exists, then the controller 16 can select the combination as an optimum combination. If there are a plurality of combinations, all of which include a maximum number of worker-prioritized LONs, from among a plurality of combinations the total man-hours MHtotal of which is minimum, then the controller 16 judges whether there is one combination, which includes a LON having the smallest branch number among the worker-prioritized LONs (in this case, a LON with no branch number is handled as a LON having a branch number of 0). If such a combination exists, then the controller 16 can select the combination as an optimum combination. If there are a plurality of combinations, each of which includes a LON having the smallest branch number from among the worker-prioritized LONs, then the controller 16 judges whether or not there is one combination, which includes a majority of worker-prioritized LONs positioned at an uppermost level on the screen of the monitor 20, as shown in FIG. 2 for example. If such a combination exists, then the controller 16 can select the combination as an optimum combination.

If the controller 16 is capable of selecting an optimum combination based on the worker-prioritized LON (S24: YES), then in step S25, the controller 16 selects an optimum combination based on the worker-prioritized LON. If he controller 16 is not capable of selecting an optimum combination based on the worker-prioritized LON (S24: NO), then control proceeds to step S26.

In step S26, the controller 16 judges whether or not it is possible to select an optimum combination from among a plurality of combinations, the total man-hours MHtotal of which is minimum, based on a system priority operation number (hereinafter referred to as a “system priority LON”). The system priority LON is stored in advance in the storage unit 14 as a LON that the guidance system 10 uses preferentially. The controller 16 can judge whether or not it is possible to select an optimum combination in step S26, in the same manner as in step S24, except that the worker-prioritized LON is replaced with the system priority LON.

If the controller 16 is capable of selecting an optimum combination based on the system priority LON (S26: YES), then in step S27, the controller 16 selects an optimum combination based on the system priority LON. If the controller 16 is not capable of selecting an optimum combination based on the system priority LON (S26: NO), then in step S28, the controller 16 selects a desired one of the combinations, the total man-hours MHtotal of which is minimum, as an optimum combination.

In step S5 shown in FIG. 12, the controller 16 provides operation guidance using the combination of target operations Ot and related operations Or, which has been identified in steps S2 through S4. More specifically, if there is one combination of target operations Ot and related operations Or (S3: NO), then the controller 16 provides operation guidance using that combination. For example, if the target operations Ot are LON5 and LON7, then the controller 16 guides the worker through the target operations Ot (parts E, F) and the related operations Or (parts A, B), in a sequence from part A (detachment), to part B (detachment), to part E (detachment), to part G (detachment), to part G (adjustment of a replacement part/dedicated added man-hours, attachment), to part E (attachment of the replacement part), to part B (attachment), and to part A (attachment).

If there are a plurality of combinations of target operations Ot and related operations Or (S3: YES), then the controller 16 provides operation guidance using the optimum combination selected in step S4. For example, if the target operations Ot are LON3 and LON7, then there are two combinations of target operations Ot and related operations Or. The first combination includes LON3 and LON7 as the target operations Ot, and LON1 and LON2 as the related operations Or. The second combination includes LON3-1 and LON7 as the target operations Ot, and LON1 as the related operation Or.

The total man-hours MHtotal of the first combination is 50 minutes (=FRT 10 [min] for LON1+FRT 10 [min] for LON2+FRT 10 [min] for LON3+common added man-hours [min] for LON3+FRT 5 [min] for LON7, and dedicated added man-hours 5 [min] for LON7). The total man-hours MHtotal of the second combination is 25 minutes (=FRT 10 [min.] for LON1+FRT 5 [min.] for LON7+dedicated added man-hours 5 [min.] for LON7+FRT 5 [min.] for LON3-1). Therefore, the total man-hours MHtotal of the second combination is smaller than the total man-hours MHtotal of the first combination. In this case, the controller 16 uses the second combination as the optimum combination, and guides the worker through the target operations Ot (LON3, LON7) and the related operation Or (LON1) in a sequence from part A (detachment), to part G (detachment), to part C (detachment), to part C (attachment of a replacement part), to part G (adjustment of a replacement part/dedicated added man-hours, attachment), and to part A (attachment).

Operation guidance may be provided, for example, by displaying items of the related operations Or and the target operations Ot in a sequence of operations in a lefthand area of the screen displayed on the monitor 20, and also by displaying, in a scrollable fashion, detailed explanations and images of the related operations Or and the target operations Ot in a sequence of operations in another area of the screen. Alternatively, detailed explanations of the related operations Or and the target operations Ot may be displayed selectively on respective screens. In any case, the total of the FRTs for the respective operations and the total number of man-hours that have been consumed for the respective operations also are displayed. The controller 16 also calculates the labor charge based on the total man-hours MHtotal, and displays the calculated labor charge together with the total man-hours MHtotal.

5. Advantages of the Present Embodiment:

According to the present embodiment, as described above, the controller 16 guides the worker through a removal and installation procedure for which the total man-hours MHtotal up to a target operation Ot is minimum, from among a plurality of calculated removal and installation procedures. When a target operation Ot is to be performed, therefore, it is possible to guide the worker through a removal and installation procedure for which the total man-hours MHtotal is minimum, as well as to calculate the overall man-hours with ease.

According to the present embodiment, the controller 16 determines a plurality of combinations of target operations Ot and related operations Or, and guides the worker through related operations Or and the target operation Ot using the combination, the total man-hours MHtotal of which is minimum from among the determined combinations. When providing guidance for a target operation Ot that is selected by the worker, therefore, it is possible to guide the worker through an operating procedure the total man-hours MHtotal of which is minimum, irrespective of the experience and skill of the worker, as well as to calculate the overall man-hours with ease.

According to the present embodiment, when a plurality of target operations Ot have been indicated through the input unit 12, the controller 16 uses one, from among all of the combinations of removing and installing operations, for which the total man-hours MHtotal up to the indicated target operations Ot is minimum, thereby guiding the worker through related operations Or and the target operations Ot. In this manner, the controller 16 can eliminate overlapping related operations Or required by the target operations Ot, can guide the worker through the target operations Ot with a minimum number of related operations Or, and can calculate the total man-hours MHtotal appropriately.

According to the present embodiment, for guiding the worker through a removal and installation procedure, the controller 16 displays the total FRTs up to each operation, to enable the worker to compare the total FRTs up to each related operation Or with actual man-hours, in order to confirm the level of skill thereof.

According to the present embodiment, if there are a plurality of removal and installation procedures the total man-hours MHtotal of which is minimum, then the controller 16 selects a combination that includes as many worker-prioritized LONs as possible. The controller 16 is thus capable of guiding the worker preferentially through one of the removal and installation procedures, the total man-hours MHtotal of which is minimum, and which the worker considers to be preferable, including related operations Or that the worker is skilled enough to perform.

According to the present embodiment, a combination of operation description data, which is preset for respective removal and installation procedures, is not displayed successively, but rather, operation description data for respective operations of parts can be recombined and displayed depending on the selected removal and installation procedure. Therefore, even if there are a plurality of removal and installation procedures, it is not necessary to prepare a plurality of combinations of operation description data, but rather, operation description data can be recombined and displayed depending on the selected removal and installation procedure, thereby resulting in high versatility.

According to the present embodiment, the controller 16 selects a removal and installation procedure the total man-hours MHtotal of which for an indicated target operation Ot (removal and installation or changing of a target part Pt) is minimum, and displays operation description data along with the selected removal and installation procedure. Therefore, operation description data can be recombined and displayed along with a removal and installation procedure, the total man-hours MHtotal of which is minimum. Accordingly, the worker is capable of performing operations efficiently regardless of the experience and skill of the worker.

According to the present embodiment, when a plurality of target operations Ot have been indicated through the input unit 12, the controller 16 displays operation description data along one from among all of the combinations of removal and installation procedures, the total man-hours MHtotal of which for the target operations Ot is minimum. Consequently, the worker can perform operations efficiently, even if a plurality of target operations Ot are indicated. Such efficient operations are highly advantageous, particularly when a large apparatus including a vast number of parts, such as a vehicle, is to be serviced.

According to the present embodiment, when a plurality of target operations Ot are indicated through the input unit 12, the controller 16 determines related operations Or between the target operations Ot, using preceding LONs, and guides the worker through the target operations Ot using the determined related operations Or. Further, according to the present embodiment, first related operations Or can follow from the respective target operations Ot using the preceding LONs. As a result, it is possible to identify related operations Or, and to guide the worker through the target operations Ot using the identified related operations Or. If a plurality of target operations Ot are selected, therefore, the controller 16 can guide the worker efficiently through the target operations while omitting overlapping related operations Or.

### B. Modifications

The present invention is not limited to the above embodiment, but may employ various alternative arrangements based on the disclosure of the present invention. For example, the present invention may employ the following alternative arrangements.

In the above embodiment, for indicating a target part Pt, a target operation Ot for the target part Pt is entered. However, the parts and operations may be stringed together, and a target operation Ot may be entered directly. In the present embodiment, although the guidance system 10 is installed in a vehicle service shop, the guidance system may be installed in other locations, such as vehicle sales shops, vehicle maintenance training organizations, etc. The guidance system 10 may be constructed as a net-work, such that data are stored in a server and each terminal acquires data from the server.

In the above embodiment, target operations Ot and related operations Or are displayed on the monitor 20 for providing visual operation guidance. However, the target operations Ot and the related operations may also be output from a speaker for providing operation guidance by speech or voice.

In the above embodiment, the controller 16 selects a removal and installation procedure for which the total man-hours MHtotal up to an indicated target operation Ot (removal and installation of a target part Pt) is minimum. Stated otherwise, the controller 16 selects a removal and installation procedure based on a rule for selecting a removal and installation procedure, for which the total man-hours MHtotal up to the indicated target operation Ot is minimum. However, the controller 16 may also select a removal and installation procedure based on a different rule. For example, the controller 16 may select a removal and installation procedure based on a rule for selecting a removal and installation procedure, so as to include operations that are manually selected by the worker. In such a case, the operation description data can be recombined and displayed in a manual fashion.

In the above embodiment, target operations Ot and related operations Or refer to removal and installation, or refer to changing only. However, such operations may include other operations for inspecting, adjusting, machining, attaching or installing (without detaching or removing), and detaching or removing (without attaching or installing) a part. In this case, when a part (target operation Ot) in the tree diagram, which is displayed on the monitor 20, is double-clicked using the mouse 24, a selection screen is displayed for selecting an operation, i.e., at least one of operations for inspecting, adjusting, machining, removing and installing (without changing), attaching or installing (without detaching or removing), and detaching or removing (without attaching or installing) a part, and one of the operations can be selected using the keyboard 22 or the mouse 24. FRTs, common added man-hours, and dedicated added man-hours of such operations may be stored in advance in the working DB 18.

In the above embodiment, related operations Or for guiding the worker include detachment of related parts Pr prior to target operations Ot, and attachment of related parts Pr subsequent to target operations Ot. However, related operations Or for guiding the worker may include only detachment of related parts Pr prior to target operations Ot. Similarly, in the above embodiment, both man-hours for detachment of related parts Pr prior to target operations Ot, and man-hours for attachment of related parts Pr subsequent to target operations Ot are considered as FRTs, common added man-hours, and dedicated added man-hours of related operations Ot. However, only man-hours for detachment of related parts Pr prior to target operations Ot may be considered as FRTs, common added man-hours, and dedicated added man-hours of related operations Ot.

In the above embodiment, the total man-hours MH of each combination of target operations Ot and related operations Or is used as a judgment criterion. However, a combination made up only of related operations Or may also be used as a judgment criterion.

1. An operating procedure guidance system for guiding a worker through an operating procedure for either one or both of removing a part attached to an apparatus and installing the part on the apparatus, comprising:
a working database for storing, with respect to each of operations for respective parts, a pair of an order for removal or installation in connection with other parts, and required standard man-hours;
an input unit for indicating a target part to be removed or installed; and
an operation guidance unit for calculating an order for either one or both of removal and installation of related parts for removal or installation of the indicated target part and a total standard man-hours required for either one or both of the removal and installation of the related parts, using data stored in the working database, and for guiding the worker through the order for either one or both of the removal and installation using calculated results,
wherein the operation guidance unit guides the worker through a removal and installation procedure, for which the total standard man-hours required for removal or installation of the target part is minimum, among a plurality of calculated removal and installation procedures representing orders for removal and installation.

2. The operating procedure guidance system according to claim 1, wherein when a plurality of target parts are indicated through the input unit, the operation guidance unit guides the worker through one of all of the combinations of the orders for either one or both of removal and installation related to the target parts and registered in the working database, for which the total standard man-hours required for either one or both of removal and installation of the indicated target parts is minimum.

3. The operating procedure guidance system according to claim 1, wherein the operation guidance unit displays the total standard man-hours required for either one or both of removing and installing the related parts for removal or installation of the target part, for guiding the worker through the removal and installation procedure.

4. The operating procedure guidance system according to claim 1, wherein if there are a plurality of removal and installation procedures, the total standard man-hours of which is minimum, then the operation guidance unit selects a procedure that includes most of the operations selected by the worker.

5. The operating procedure guidance system according to claim 1, wherein the working database stores, with respect to each of operations for respective parts, the order for either one or both of removal and installation, the standard man-hours, and operation description data in combination; and
the operation guidance unit selects a removal and installation procedure, the total standard man-hours of which for removal or installation of the indicated target part is minimum, and displays operation description data for the target part and related parts up to the target part, correspondingly to and in combination with the order for either one or both of the selected removal and installation.

6. The operating procedure guidance system according to claim 5, wherein when a plurality of target parts are indicated through the input unit, the operation guidance unit displays the operation description data for the target parts and related parts up to the target parts, correspondingly to and in combination with the order for one of all of the combinations of removal and installation procedures, the total standard man-hours of which for either one or both of removal and installation of the indicated target parts is minimum.
